(19) United States
(12) Patent Application Publication
(10) Pub. No.: US 2008/0267827 A1
(43) Pub. Date: Oct. 30, 2008

(54) CONTENTS TRANSFER APPARATUS AND CHEMICAL REACTION SYSTEM

(75) Inventors: Takeo TANAAMI, Musashino-shi (JP); Isao UCHIDA, Musashino-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: YOKOGAWA ELECTRIC CORPORATION, Tokyo (JP)

(21) Appl. No.: 12/046,223

(22) Filed: Mar. 11, 2008

(30) Foreign Application Priority Data
Apr. 27, 2007 (JP) 2007-117984

(51) Int. Cl. B01L 11/00

(52) U.S. Cl. 422/99

(57) ABSTRACT

A contents transfer apparatus applicable to various chemical reaction cartridges for general purpose, and a chemical reaction system are provided. The contents transfer apparatus comprises a plurality of members, arrayed substantially continuously, and driving means for independently driving the plurality members. Since the plurality of members are driven independently of each other, it is possible to transfer the contents of the cartridge with the same operation as made by use of rollers, and also possible to transfer the contents with more smooth pulsative operation.

### FIELD OF THE INVENTION

The invention relates to a contents transfer apparatus capable of causing deformation to occur to a chemical reaction cartridge upon application of an external force thereto, and transferring contents thereof, thereby causing chemical reaction to proceed, and a chemical reaction system using the chemical reaction cartridge.

### BACKGROUND OF THE INVENTION

A chemical reaction cartridge capable of causing deformation to occur thereto so as to transfer contents thereof, thereby causing chemical reaction to proceed, has been under development (for example, disclosed in JP 2005-37368 A). With this cartridge, a space for enabling chemical reaction to occur is provided therein, and the contents thereof are caused to undergo a predetermined chemical reaction, by transferring contents thereof in the space, due to deformation occurring thereto, upon application of an external force thereto. According to this cartridge, a protocol for chemical reaction can be determined due to a structure itself of the cartridge while a hermetically sealed state is maintained, so that the protocol as desired can be safely executed without a personal error.

With the use of the cartridge described as above, a complicated procedure can be efficiently executed. Particularly, a complicated transfer procedure can be achieved with less paths by employment of an apparatus adapted to individual cartridges, such as a combination of a plurality of rollers. However, if the protocols and applications for the cartridges are different from each other, the same apparatus can not be used, so that respective apparatuses adapted to the respective cartridges have to be prepared.

### SUMMARY OF THE INVENTION

It is therefore an object of the invention to provide a contents transfer apparatus applicable to various chemical reaction cartridges for general purpose, and a chemical reaction system.

In accordance with one aspect of the invention, there is provided a contents transfer apparatus capable of causing deformation to occur to a chemical reaction cartridge upon application of an external force thereto, and transferring contents thereof, thereby causing chemical reaction to proceed, characterized in that the contents transfer apparatus comprising a plurality of members, arrayed substantially continuously, capable of being pushed against the chemical reaction cartridge, and driving means for independently driving the plurality members so as to cause respective members to be pushed against the chemical reaction cartridge.

With the contents transfer apparatus described as above, since the plurality of members which are arrayed substantially continuously can be driven independently of each other, the contents transfer apparatus can be applicable to various chemical reaction cartridges for general purpose.

Respective widths of respective contact surfaces of respective members of the contents transfer apparatus relative to the chemical reaction cartridge in the transfer direction of the contents is smaller than respective wells defined in the chemical reaction cartridge in the same direction.

There is further provided control means for controlling the driving means so as to drive the members in a predetermined procedure.

Shapes of respective contact surfaces of respective members relative to the chemical reaction cartridge may be circular or polygonal.

Shapes of respective contact surfaces of respective members relative to the chemical reaction cartridge may be formed by densely disposing respective contact surfaces.

The respective members can apply heat or vibration to the chemical reaction cartridge.

In accordance with a second aspect of the invention, there is provided a chemical reaction system using a chemical reaction cartridge capable of causing deformation to occur thereto so as to transfer contents thereof, thereby causing chemical reaction to proceed, said chemical reaction system is characterized in comprising a contents transfer apparatus comprised of a plurality of members, arrayed substantially continuously, capable of being pushed against the chemical reaction cartridge, and driving means for independently driving the plurality members so as to cause respective members to be pushed against the chemical reaction cartridge.

With the chemical reaction system described as above, since the contents transfer apparatus for driving a plurality of members, arrayed substantially continuously, independently of each other can be used, the chemical reaction system can be applicable to various chemical reaction cartridges for general purpose.

### BRIEF DESCRIPTION OF THE DRAWINGS

FIG. 1 is a view showing a configuration of a contents transfer apparatus according to an embodiment of the invention, wherein FIGS. 1(A) and 1(B) are front views showing configurations of the contents transfer apparatus;

FIG. 2 is a view showing examples of shapes of contact surfaces of a plurality of members, wherein FIG. 2(A) is a plan view of circular contact surfaces, and 1(B) is a plan view of hexagonal contact surfaces;

FIG. 3 is a partially enlarged view showing the configuration of the contents transfer apparatus;

FIG. 4 is a view showing operations of transferring the contents of the chemical reaction cartridge, wherein FIG. 4(A) to (C) are front views showing the transfer conditions with time series;

FIG. 5 is a view showing various driving systems, wherein FIG. 5(A) shows an example to use a rotary type actuator, FIG. 5(B) shows an example to use a different type of actuator, and FIG. 5(C) shows an example to drive members by a pressure; and

FIG. 6 is a view showing a mechanism provided at the upper and lower portions of a cartridge to push the cartridge therebetween.

### PREFERRED EMBODIMENTS OF THE INVENTION

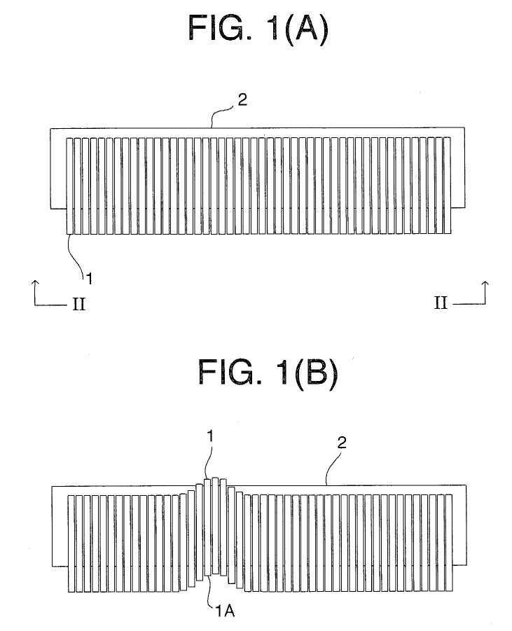

Embodiments of a contents transfer apparatus according to the invention are described hereinafter with reference to FIGS. 1 to 6.

FIGS. 1(A) and 1(B) are front views showing configurations of the contents transfer apparatus, according to the embodiment of the invention.

As shown in FIG. 1(A), the contents transfer apparatus according to the embodiment is provided with a plurality members 1, 1, . . . and driving means 2 for driving the members 1, 1, up and down independently of each other.

As shown in FIG. 1(B), the driving means 2 can drive an optional member 1, independent of other members 1, 1, . . . for example it can form an optional curved shape by displacing contact surfaces 1A of the adjoining members 1, 1, . . . up and down little by little.

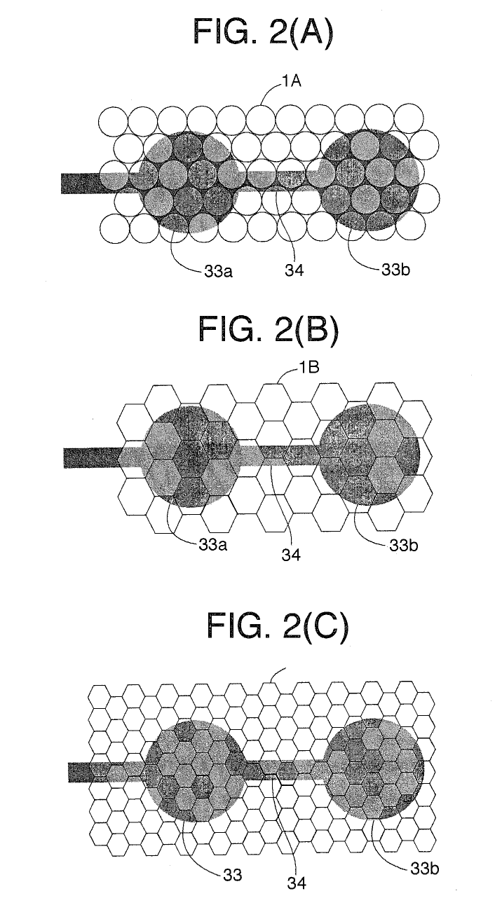

FIG. 2(A) is a plan view showing an example of each contact surface 1A of the members 1, 1, . . . as seen from the direction of the line II-II in FIG. 1. As shown in FIG. 2(A), the contact surfaces are circular, and respective members 1, 1, . . . are arrayed so to be closely brought into contact with each other on each level surface as viewed from above. Each member 1 may be formed of a fluorine resin, and so forth so as to reduce a sliding resistance between the members 1, 1, . . . which are closely brought into contact with each other. A diameter of each contact surface 1A is smaller than each diameter of wells 33a, 33b of a cartridge, thereby causing the contents of the cartridge to be smoothly transferred. The size and shape of the contact surface 1A are selected in a range within which the contents can be transferred in relation to at least the well or a flow path of the cartridge.

In the example of FIG. 2(A), there is illustrated an example of the structure wherein the wells 33a and 33b of the cartridge are connected to each other via a flow path 34.

FIG. 2(B) and FIG. 2(C) are plan views showing examples of different shapes of the contact surfaces of the members.

FIG. 2(B) shows a case where each hexagonal contact surface 1B has a hexagonal dense structure. In this case, there is no gap between the members 1, 1, . . . , causing the contents to be transferred with more reliability. FIG. 2(C) shows a case where the area of a contact surface 1C is rendered more small. In this case, the contents can be more smoothly transferred so that it can cope with a cartridge having more minute structure. Each contact surface may have other shapes such as triangular, square, causing the contact surface to have a dense structure.

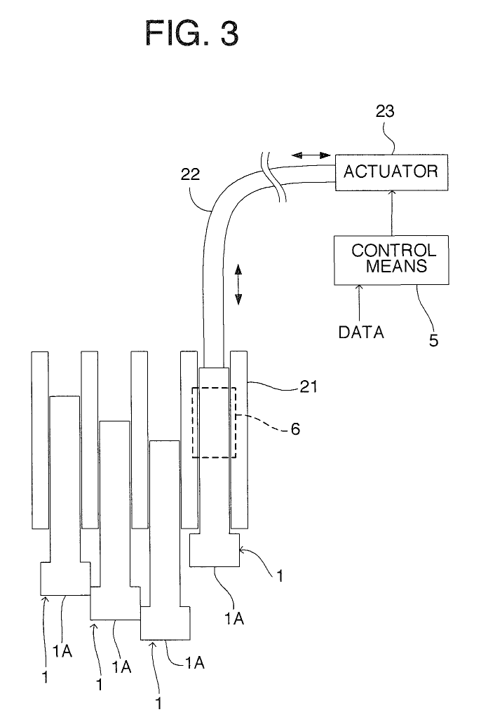

FIG. 3 is a partially enlarged view showing the configuration of the contents transfer apparatus.

As shown in FIG. 3, each member 1 is slidably supported by support members 21, and it is connected to a movable element of an actuator 23 via a wire 22. The support members 21, the wire 22 and the actuator 23 constitute driving means. It may be configured that the adjoining members 1, 1, . . . are slidably supported by each other, in which case the support members 21 for partitioning the members 1 may be dispensed with.

When the actuator 23 is operated, the wire 22 is moved axially so that the member 1 is moved vertically. Meanwhile, in FIG. 3, only one set of wire 22 and actuator 23 are illustrated, but the wire 22 and actuator 23 are provided for all other members 1, 1, . . . . As a result, the respective members 1, 1, . . . are driven independently of each other.

As shown in FIG. 3, control means 5 is connected to the actuators 23, 23 . . . , and the actuators 23, 23 . . . are operated in a prescribed timing in response to a command from the control means 5. A driving procedure of the members 1, 1, . . . , namely, data for determining a procedure for transferring the contents is received in advance by the control means 5, and the control means 5 transmits the command to the actuators 23, 23 . . . in response to this data.

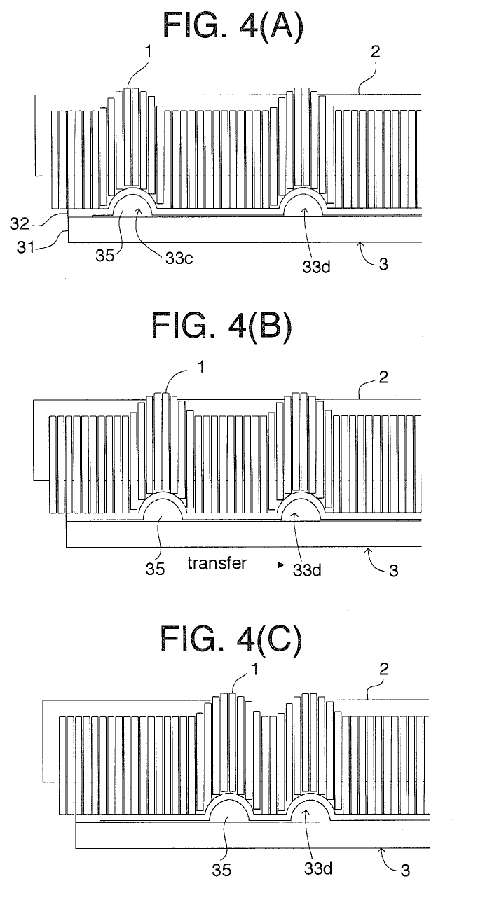

FIGS. 4(A) to (C) are front views showing operations of transferring the contents of the chemical reaction cartridge. As shown in FIGS. 4(A) to (C), a cartridge 3 comprises a base member 31 and an elastic member 32 which is overlaid on the base member 31, and wells 33c and 33d are formed by recesses of the elastic member 32. A flow path, not shown, is formed between the wells 33c and 33d.

In the example shown in FIGS. 4(A) to (C), transfer conditions are illustrated with time series in the order of FIGS. 4(A) to (C), wherein the members 1, 1, . . . which are pushed against the cartridge 3 are sequentially caused to be moved from the left to the right, thereby causing the elastic member 32 of the cartridge 3 to be deformed by the contact surface 1A, so that a liquid 35 in the well 33c is transferred rightward toward the well 33d.

According to the contents transfer apparatus of the embodiment, since the plurality of members 1, 1, . . . are driven independently of each other, it is possible to transfer the contents of the cartridge with the same operation as made by use of rollers, and also possible to transfer the contents with more smooth pulsative operation.

With the configuration of the contents transfer apparatus of the embodiment described as above, the driving procedure of the members 1, 1, . . . can be optionally set in response to data to be received by the control means 5, the contents transfer apparatus can cope with optional protocols and applications, and can use a common mechanism relative to different cartridges.

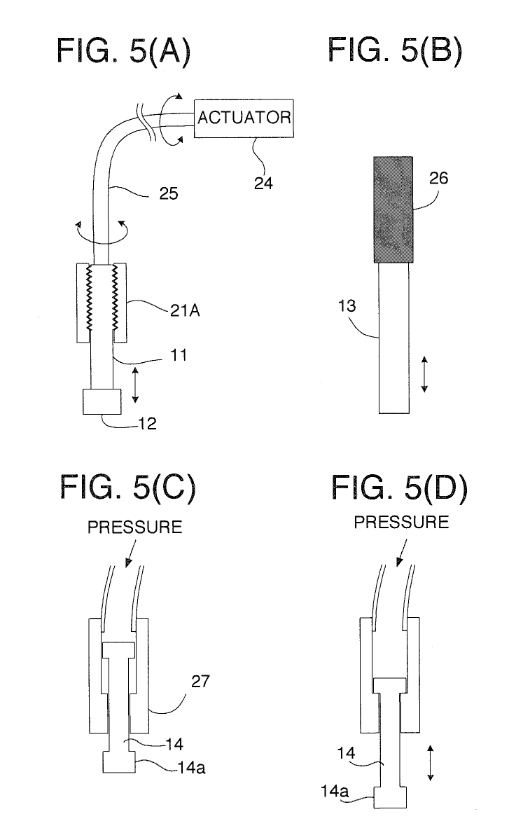

FIG. 5(A) shows an example to use a rotary type actuator. In this case, the rotation of a rotor of an actuator 24 is transmitted to a rotary member 11 via a wire 25. The rotary member 11 is threadably mounted on a support member 21A and the rotation of the rotary member 11 is converted into a vertical movement. A contact member 12 is rotatably attached to the tip end of the rotary member 11, and it is pushed against the cartridge 3 while it is not rotated relative to the cartridge 3.

FIG. 5(B) shows an example to use a different type of actuator. In this case, each member 13 is driven by an actuator 26 comprised of a piezo element or an electrostatic actuator.

FIG. 5(C) shows an example to drive the members by use of a pressure. In this example, a member 14 is slidably supported by a support member 27 so that the member 14 is driven downward by the pressure such as a hydraulic pressure, oil pressure, air pressure and so forth to be supplied inside the support member 27. The member 14 is provided with a fitting part 14a to prevent the member 14 from being come off, and as shown in FIG. 5(D), when the fitting part 14a is brought into contact with the support member 27, the moving range of the member 14 is restricted.

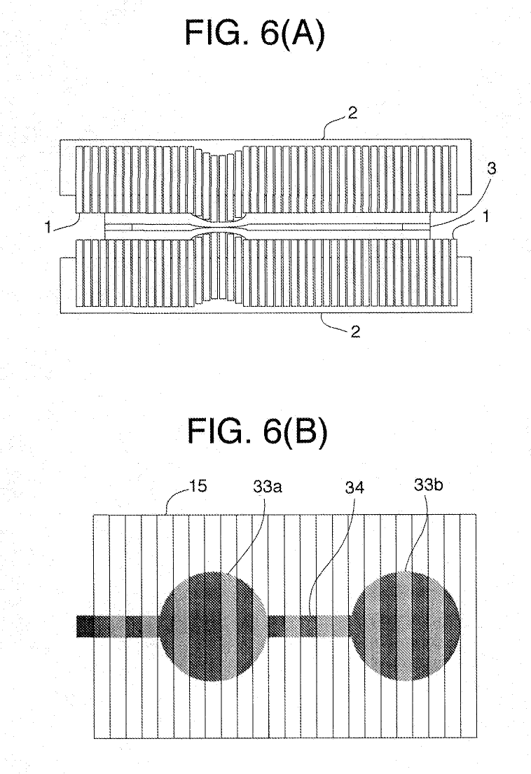

According to the embodiment described as above, although there was described the case where the members are pushed against the cartridge from one side (upper side), mechanisms for pushing the cartridge therebetween, namely contents transfer apparatuses may be provided on the upper and lower portions of the cartridge 3 as shown in FIG. 6(A). In this case, the contents transfer apparatuses (FIG. 1) may be provided on the cartridge while they are turned upside down, and at the same time, the members 1, 1, . . . are driven, causing the contents of the cartridge 3 to be transferred.

In the example, shown in FIG. 6(A), the members 1, 1, . . . are provided in a two-dimensional array on each level surface, causing the contents to be transferred to an optional direction on each level surface. Whereupon, in the case where the contents are enough to be transferred one-dimensionally (linearly), as shown in FIG. 6(B), members 15, 15, . . . which are rectangular in shape and elongate in contact surfaces may be arrayed unidirectionally. In this case, the contents can be transferred only unidirectionally, namely, right or left, but the number of the members 15, 15, . . . may be decreased considerably, so that the contents transfer apparatus can be configured with ease.

It may be possible to apply heat to the cartridge while the cartridge is pushed into the contents transfer apparatus. For example, as shown in FIG. 3, a heat source 6 for heating the cartridge via the member 1 may be provided for every member 1 to regulate the temperature of the cartridge. Further, heat may be applied to each member 1 via a thermal conductive wire 22. It is possible to heat the individual members 1, 1, . . . selectively by irradiating the members 1, 1, . . . with infrared ray via the wire 22 while each wire 22 is formed of an optical transparent material. Still further, it is possible to heat the entire surface of the cartridge by heating the entire support members 21.

It may be possible to apply vibration to the cartridge while the cartridge is pushed into the contents transfer apparatus. In this case, for example, as shown in FIG. 3, when the member 1 is vibrated longitudinally by the actuator 23, vibration can be applied to the portion of the cartridge corresponding to the member 1. An actuator such as piezo element, electrostatic actuator for applying vibration to the cartridge may be provided separately in the vicinity of the member 1.

As mentioned in detail above, according to the contents transfer apparatus of the invention, a plurality of members arrayed substantially continuously can be driven independently with each other, it can be applicable to various chemical reaction cartridges for general purpose. Further, according to the chemical reaction system of the invention, the contents transfer apparatus for driving a plurality of members arrayed substantially continuously independently with each other can be used, it can be applicable to various chemical reaction cartridges for general purpose.

It is to be pointed out that the invention is not limited in scope of application to the examples described hereinbefore. The invention can be widely applied to the contents transfer apparatus capable of causing deformation to occur to a chemical reaction cartridge upon application of an external force thereto, and transferring contents thereof, thereby causing chemical reaction to proceed, and a chemical reaction system using the chemical reaction cartridge.

1. A contents transfer apparatus capable of causing deformation to occur to a chemical reaction cartridge upon application of an external force thereto, and transferring contents thereof, thereby causing chemical reaction to proceed, said contents transfer apparatus comprising:
a plurality of members, arrayed substantially continuously, capable of being pushed against the chemical reaction cartridge; and
driving means for independently driving the plurality members so as to cause respective members to be pushed against the chemical reaction cartridge.

2. The contents transfer apparatus according to claim 1, wherein respective widths of respective contact surfaces of respective members of the contents transfer apparatus relative to the chemical reaction cartridge in the transfer direction of the contents is smaller than respective wells defined in the chemical reaction cartridge in the same direction.

3. The contents transfer apparatus according to claim 1, further provided with control means for controlling the driving means so as to drive the members in a predetermined procedure.

4. The contents transfer apparatus according to claim 1, wherein shapes of respective contact surfaces of respective members relative to the chemical reaction cartridge are circular or polygonal.

5. The contents transfer apparatus according to claim 1, wherein shapes of respective contact surfaces of respective members relative to the chemical reaction cartridge are formed by densely disposing respective contact surfaces.

6. The contents transfer apparatus according to claim 1, wherein respective members can apply heat or vibration to the chemical reaction cartridge.

7. A chemical reaction system using a chemical reaction cartridge capable of causing deformation to occur thereto so as to transfer contents thereof, thereby causing chemical reaction to proceed, said chemical reaction system comprising:
a contents transfer apparatus comprised of a plurality of members, arrayed substantially continuously, capable of being pushed against the chemical reaction cartridge; and
driving means for independently driving the plurality members so as to cause respective members to be pushed against the chemical reaction cartridge.
